(19) United States
(12) Patent Application Publication
(10) Pub. No.: US 2014/0298710 A1
(43) Pub. Date: Oct. 9, 2014

(54) ANIMAL TRAP

(71) Applicant: Joseph Pomerantz, Moorpark, CA (US)

(72) Inventor: Joseph Pomerantz, Moorpark, CA (US)

(21) Appl. No.: 14/247,624

(22) Filed: Apr. 8, 2014

Related U.S. Application Data
(60) Provisional application No. 61/810,153, filed on Apr. 9, 2013.

(51) Int. Cl. A01M 23/18

(52) U.S. Cl. CPC A01M 23/18
USPC 43/61

(57) ABSTRACT

A humane animal trap includes an enclosure having an opening with a door disposed therein. The door is pivotable about an upper edge between open and closed positions, and is biased toward the closed position by a torsion spring. A transfer arm is disposed along a side of the enclosure and has a catch that is biased into engagement with the door when the door is in the open position and a trip release is engaged with the transfer arm. The transfer arm is operable to rotate the catch away from the entry door in response to disengagement of the trip release. A mechanical sensor is disposed in the enclosure and includes a trip pad coupled to the trip release. The mechanical sensor disengages the trip release from the transfer arm when an animal enters the trap, thereby closing the door behind the animal and capturing it unharmed.

### BACKGROUND

1. Field of the Invention

This disclosure relates to traps for animals, in general, and in particular, to “humane or “catch-and-release” animal traps that are actuated by relatively simple mechanisms.

2. Related Art

Conventional traps typically inflict pain or even death on the animals falling prey to them. More recently, however, a variety of so-called “humane,” “live” or “catch-and-release” animal traps have been developed that have as an object the capture of various types of animals, without harming or killing them, with a view to releasing the trapped animals later at another location where they are no longer a nuisance, or at which it is desirable to establish or reestablish a population of that species.

Humane traps typically include an open-ended enclosure having an internal arrangement for holding a type of bait that is selected to lure a particular type of target animal into the enclosure, and at least one entry door that can be set in an open position to enable the animal to enter the enclosure so as to approach the bait, and a “trip” mechanism that causes the entry door to close rapidly behind the animal and thereby trap the animal in the enclosure.

The trip mechanism of the trap may be entirely mechanical in nature, such as those described in, e.g., U.S. Pat. No. 7,134,237 to B. Plucknett; U.S. Pat. No. 6,684,560 to D. Lafforthun; and, U.S. Pat. No. 6,609,327 to K. Stoico et al. Alternatively, the trip mechanism may be entirely electrical in nature, such as described in, e.g., U.S. Pat. No. 6,807,767 to J.

Schade; U.S. Pat. No. 6,202,340 to J. Nieves; and, U.S. Pat. No. 6,016,623 to W. Celestine, and may include multiple trip sensor types, such as described in U.S. Pat. No. 7,051,472 to J. Kelly.

Conventional mechanical trip mechanisms are typically prone to wear and corrosion from exposure to the elements, which can adversely affect their sensitivity and/or speed of operation, and hence, reliability. More reliable mechanisms have, in the past, been more expensive and complex to implement reliably in an animal trap that may be subject to rugged outdoor environments, and are often heavier and less portable due to additional material design requirements.

Therefore, a need exists for a humane animal trap that is light in weight, inexpensive to fabricate, simple to set and use, and sufficiently robust to withstand long term use in rugged outdoor environments.

### SUMMARY

In accordance with the present disclosure, a novel humane animal trap for small to medium sized animals is provided that incorporates a relatively simple mechanical trip mechanism operating in conjunction with a mechanical spring-biased entry door, and which is light in weight, inexpensive to fabricate, simple to set and use, and sufficiently robust to withstand extended use in rugged outdoor environments.

In one exemplary embodiment, the humane animal trap comprises an elongated enclosure having an entry opening at a front end thereof. An entry door is disposed within the entry opening and pivotable about an upper hinge thereof between an entry closed position, in which the entry opening is blocked or closed, and an entry open position disposed above and spaced apart from a floor of the enclosure such that the trap is open to the entry of a target animal therein. A mechanical spring biases the entry door toward the closed position, and is further operable to lock the entry door in the closed position and against the escape of the trapped animal until intentionally released by the user.

A transfer arm may be disposed along a side of the enclosure. The transfer arm may have a catch that is biased into engagement with a bottom surface of the entry door when the entry door is disposed in the entry open position and/or a trip release is engaged with the transfer arm, so as to hold the door in the open position. The transfer arm is operable to rotate the catch from the bottom surface of the entry door in response to disengagement of the trip release, so as to release the door from the open position.

A sensor is disposed in the enclosure for sensing the presence of an animal in the enclosure, and includes a trip pad in the interior of the enclosure and coupled to the trip release. The sensor is operable to disengage the trip release from the transfer arm when an animal enters the trap, so that the entry door quickly closes behind the animal and traps it in the enclosure.

These and other features and advantages of the present disclosure will be more readily apparent from the detailed description of the embodiments set forth below taken in conjunction with the accompanying figures.

### BRIEF DESCRIPTION OF THE FIGURES

FIG. 1 is a front and right side perspective view of an embodiment of a humane animal trap in accordance with the present disclosure, showing the trap disposed in a closed position;

FIG. 2 is a right side elevation close up view of an embodiment of a humane animal trap in accordance with the present disclosure, showing the trap disposed in a closed position;

FIG. 3 is a right side elevation close up view of an embodiment of a humane animal trap in accordance with the present disclosure, showing the trap disposed in a closed position;

FIG. 4 is a front elevation view of an embodiment of a humane animal trap in accordance with the present disclosure, showing the trap disposed in a closed position;

FIG. 5 is a rear and left side perspective view of an embodiment of a humane animal trap in accordance with the present disclosure, showing the trap disposed in a closed position;

FIG. 6 is a rear elevation view of an embodiment of a humane animal trap in accordance with the present disclosure, showing the trap disposed in a closed position;

FIG. 7 is a top plan view of an embodiment of a humane animal trap in accordance with the present disclosure, showing the trap disposed in a closed position;

FIG. 8 is a bottom plan view of an embodiment of a humane animal trap in accordance with the present disclosure, showing the trap disposed in a closed position;

FIG. 9 is a front and right side perspective view of an embodiment of a humane animal trap in accordance with the present disclosure, showing the trap disposed in an open position;

FIG. 10 is a right side elevation close up view of an embodiment of a humane animal trap in accordance with the present disclosure, showing the trap disposed in an open position;

FIG. 11 is a right side elevation close up view of an embodiment of a humane animal trap in accordance with the present disclosure, showing the trap disposed in an open position;

FIG. 12 is a top plan close up view of an embodiment of a humane animal trap in accordance with the present disclosure, showing the trap disposed in an open position;

FIG. 13 is a front perspective view of an embodiment of a humane animal trap in accordance with the present disclosure, showing the trap disposed in an open position;

FIG. 14 is a front elevation view of an embodiment of a humane animal trap in accordance with the present disclosure, showing the trap disposed in an open position;

FIG. 15 is a left side elevation view of an embodiment of a humane animal trap in accordance with the present disclosure, showing the trap disposed in an open position;

FIG. 16 is a rear elevation view of an embodiment of a humane animal trap in accordance with the present disclosure, showing the trap disposed in an open position;

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

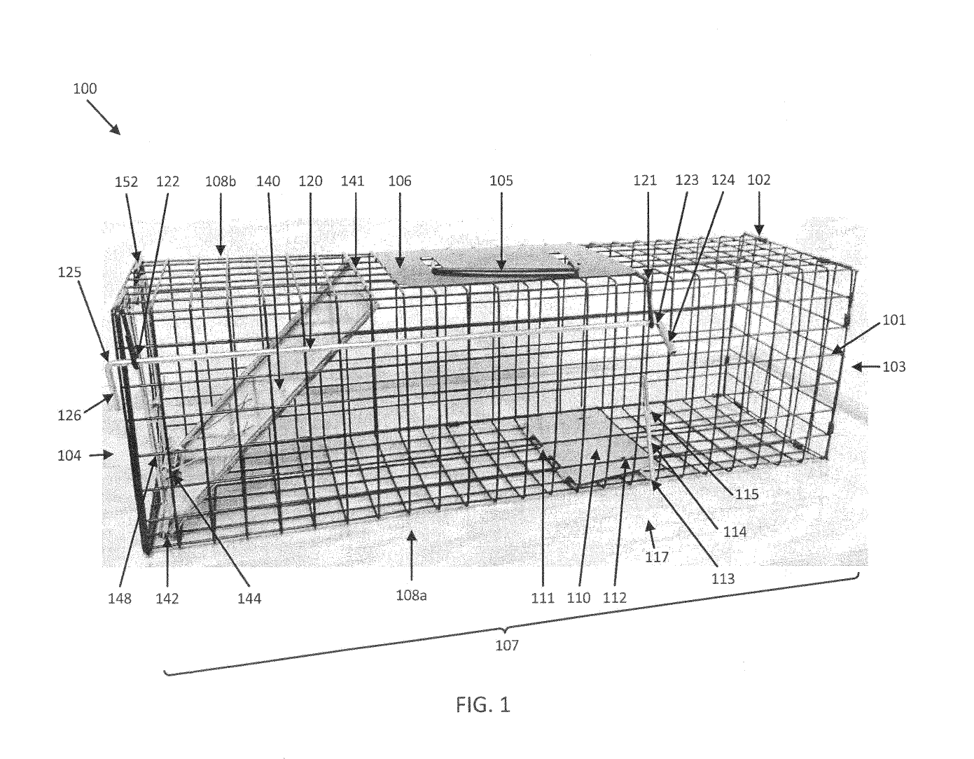

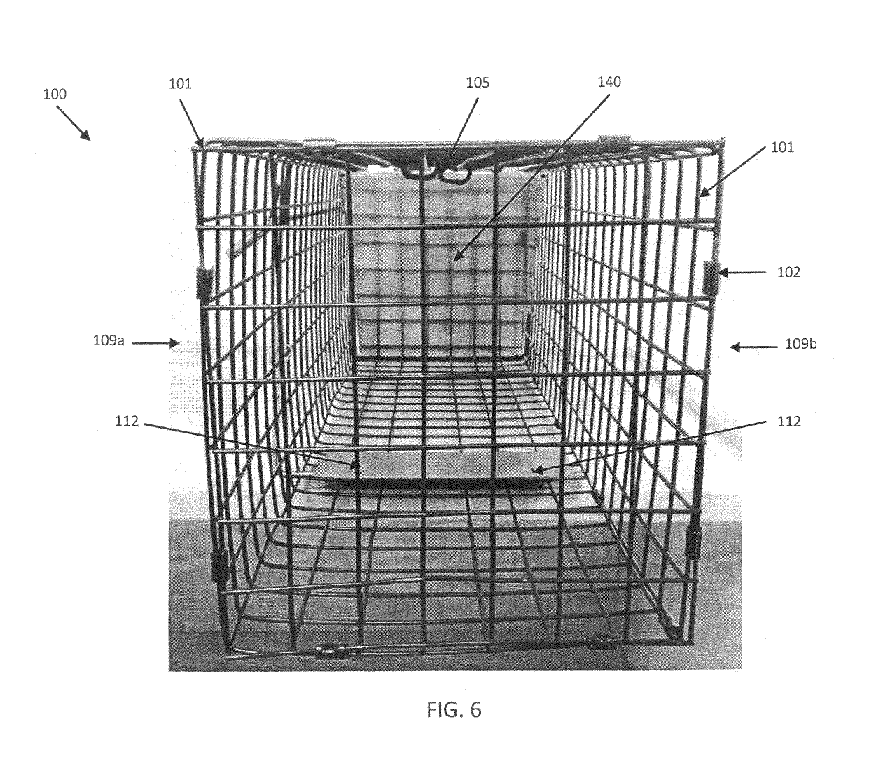

An exemplary embodiment of a humane, or “live,” animal trap 100 in accordance with the present disclosure is illustrated in the front and right side perspective view of FIG. 1. As illustrated in the several views of the figures, animal trap 100 comprises an elongated enclosure 107 having a generally rectangular cross-section, front and rear ends, a generally flat floor 108a, upstanding and generally parallel right and left sidewails 109a and 109b (see, e.g., FIG. 6), a top wall 108b, a handle 105, an entry opening 104 located at the front end thereof, and a rear wall 103 located at the rear end thereof.

In some embodiments, enclosure 107 may incorporate a wire mesh construction (e.g., including wire mesh walls 101). For example, enclosure 107 may be implemented as first and second sheets of wire mesh, for example, where the first relatively large wire mesh sheet can be bent (e.g., using three right-angle bends) into the rectangular shape shown in FIG. 1, the second relatively small wire mesh sheet can be placed at a rear end of enclosure 107, and one or more joiners 102 may be used to join (e.g., crimp, weld, fasten, or otherwise adhere, for example) the ends of the first sheet and the first sheet to the second to form the general shape of enclosure 107. Subsequently, enclosure 107 (e.g., and various other portions of trap 100) may be dip-coated, anodized, powder-coated, or otherwise sealed against environmental corrosion. Such embodiments may be manufactured quickly and inexpensively yet be reliable and robust when used outdoors over long periods of time. In other embodiments, enclosure 107 may be formed of a molded plastic, e.g., polypropylene, for additional user protection and/or a rugged resistance to corrosion resulting from extended exposure to the elements. In an alternative, more robust embodiment, the enclosure 107 may be formed from a fiber, e.g., fiberglass, reinforced epoxy resin that is laid up in the form of partially cured sections or panels in a set of conformal molds and then assembled together during the final curing of the resin.

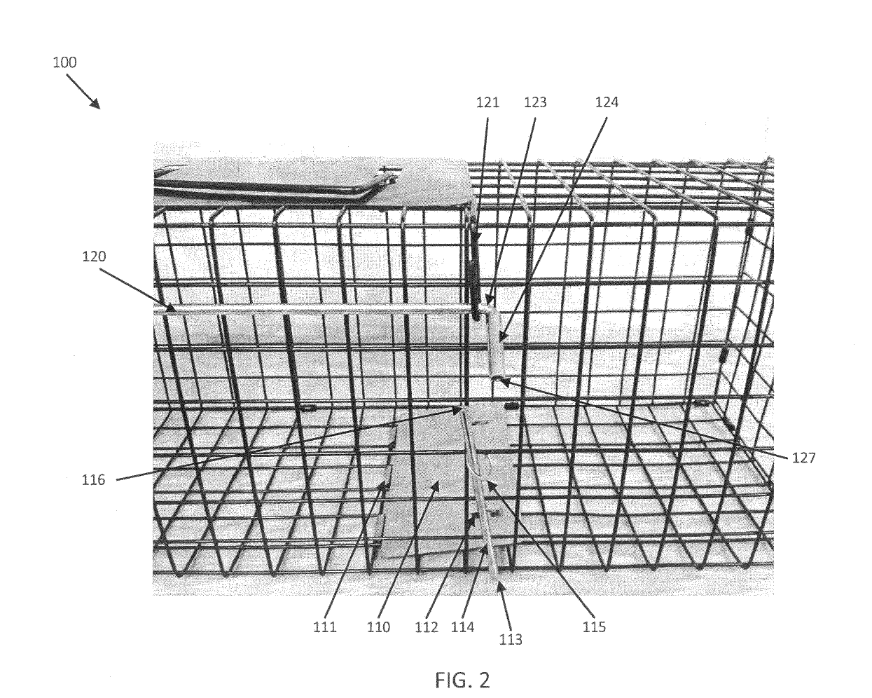

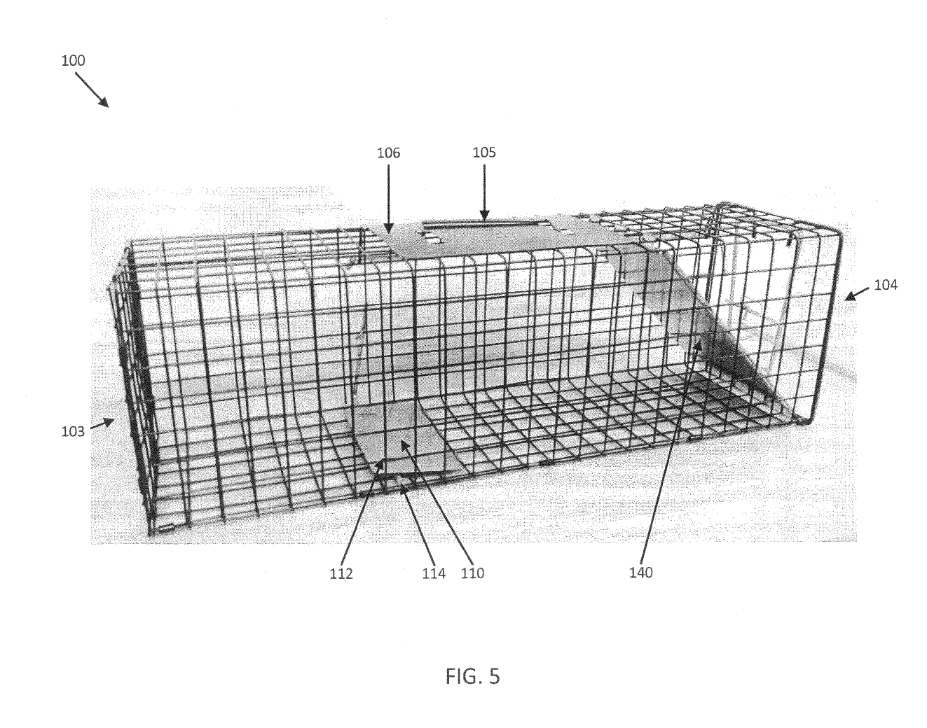

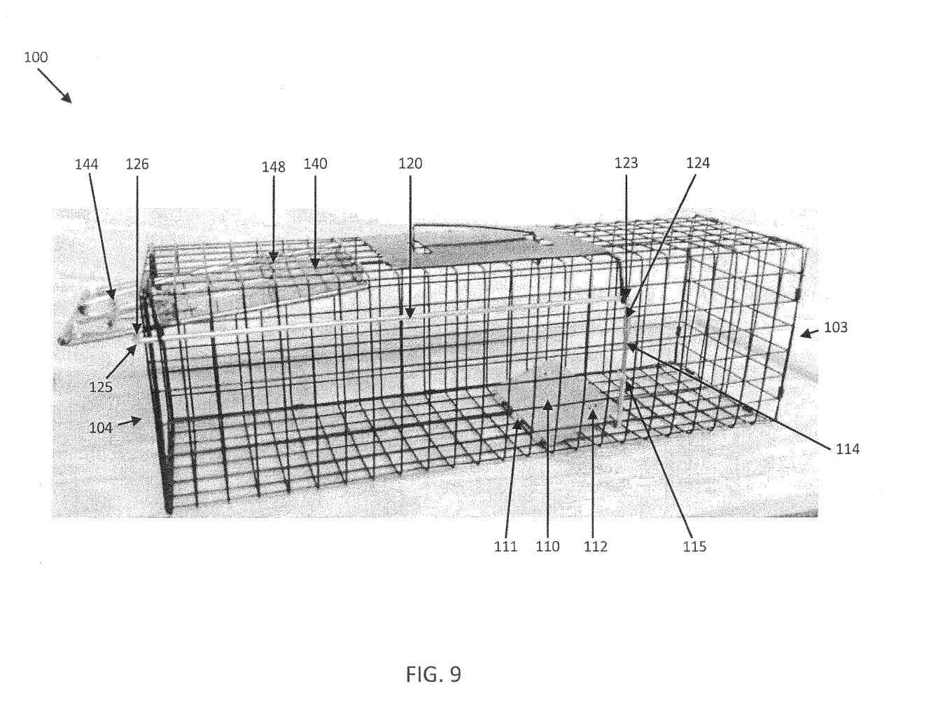

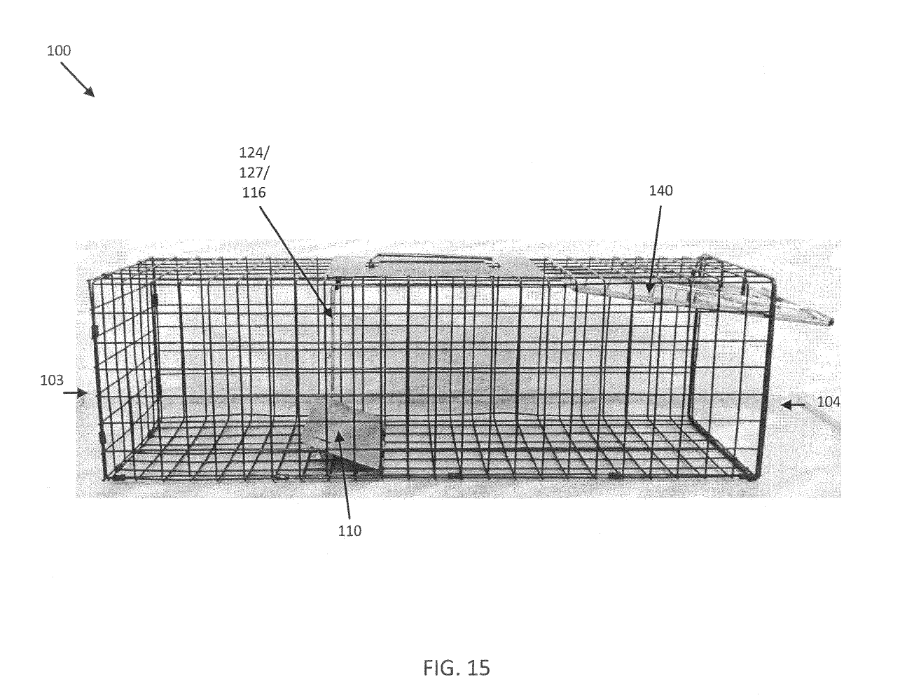

As illustrated in, e.g., FIGS. 1-2, 5, and 9-10, an animal sensor 117 may be disposed in a rear end portion of enclosure 107. In one embodiment, animal sensor 117 may include three primary parts: a trip release 114 coupled to a trip pad 110 and held substantially in a vertical alignment by a retainer 115. As illustrated in FIGS. 9-10 and 14-15, when activated, i.e., when trap 100 is “set,” animal sensor 117 engages with transfer arm 120 to retain entry door 140 in an open position. When trip pad 110 is pressed downwards, for example, by an animal entering a rear portion of trap 100, animal sensor 117 disengages with transfer arm 120 to allow entry door 140 to close, as described in more detail below.

As illustrated in FIGS. 1 and 9, trip pad 110 may be located toward the rear end portion of enclosure 107 so as to enable a target animal (not illustrated) to enter into the trap 100 completely before animal sensor 117 is tripped or “triggered.” The animal may be lured into entry opening 104 of trap 100 and toward the rear end thereof by an appropriate type of bait disposed in a holder (not illustrated) placed at the rear end of the trap.

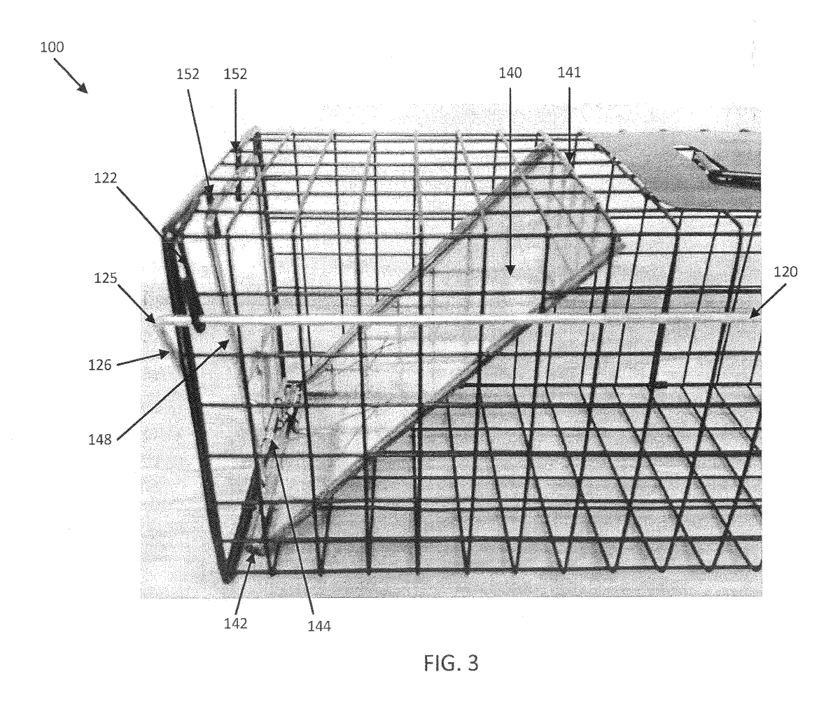

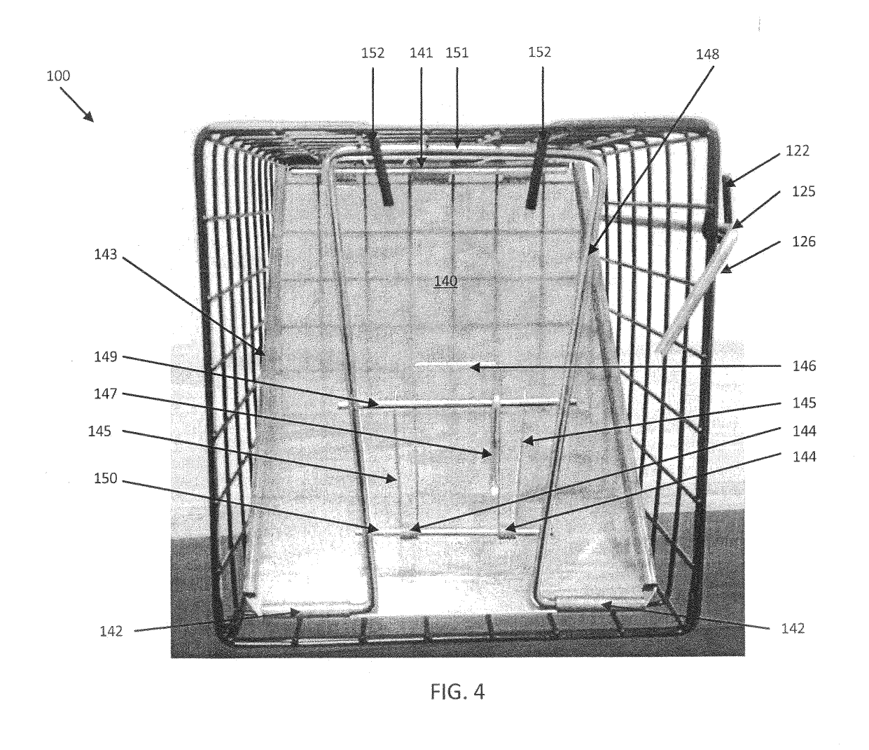

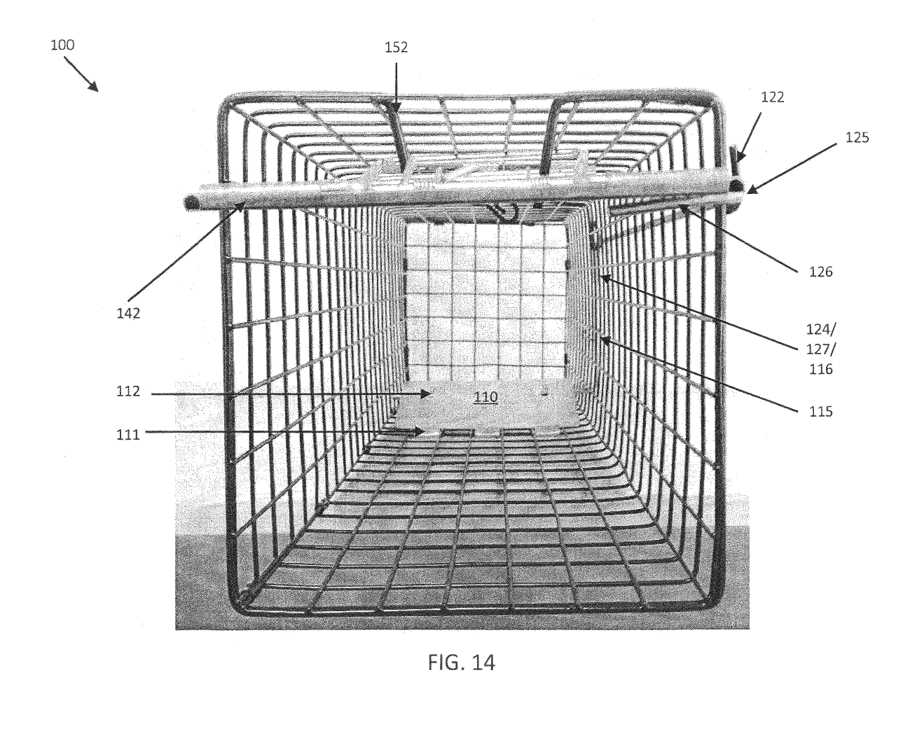

As illustrated in FIGS. 1, 3-4 and 12, a generally rectangular entry door 140 may be disposed within entry opening 104 of enclosure 107. Entry door 140 may be coupled to enclosure 107 by means of a sleeve hinge 141 formed from and/or attached to an upper edge of entry door 140 so as to allow entry door 140 to pivot about the upper edge between an “entry closed” position, as illustrated in FIG. 4, in which a lower edge of entry door 140 is disposed in forceful contact with floor 108a of enclosure 107, whereby entry door 140 substantially blocks entry opening 104, and an “entry open” position, as illustrated in FIG. 14, in which entry door 140 is disposed above and spaced apart from floor 108a. As shown in FIG. 4, entry door may include one or more reinforcement features, such as rolled edges 143, that prevent entry door 140 from buckling under stress from spring 148 and/or an animal attempting to force its way out of trap 100, for example. Notably, each of the sleeve hinges described herein may act simultaneously as hinges and as reinforcement features.

A mechanical spring 148 is used to bias entry door 140 toward the closed position illustrated in FIG. 4. In the embodiments generally illustrated in the figures, spring 148 includes a U-shaped torsion spring 144, coupled to cross-bar 150 and having legs 145, 146 acting on cross-bar 149 and a top surface of entry door 140, that actuates mechanical spring 148. As shown in FIG. 4, torsion spring 144 may be substantially retained in position, and or spring 148 within a particular range of flex, by retainer 147.

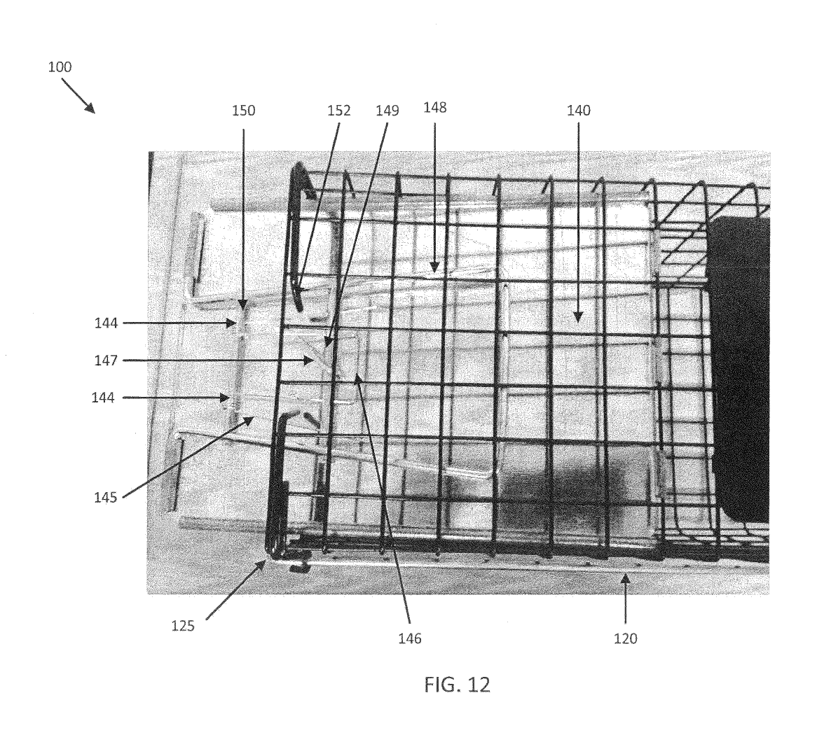

In some embodiments, mechanical spring 148 may include a pair of lower arms 142 sleeve hinged (e.g., lower arms/sleeve hinges 142) to a lower edge of the entry door 140, and an upper arm 151 disposed in sliding contact with top wall 108b of enclosure 107 and retained within enclosure 107 by at least stops 152. Spring 148 may be arranged so as to bias entry door 140 to the closed position and to lock it in that position by a wedging action by pressing against top wall 108b of enclosure 107 (e.g., and against stops 152) so as to prevent the escape of an animal from trap 100. Entry door 140 may be “unlocked” from the closed position by pressing rearwardly on upper arm 151 of spring 148 to enable door 140 to pivot to the open position illustrated in FIGS. 12, 14. Notably, although spring 148 quickly and securely closes entry opening 104, the action used to close entry door 140 may push an animal forward into the trap, towards rear wall 103, as entry door 140 is closing, thereby reducing a risk of harming and/or suffocating the animal when the trap is triggered. As will be appreciated, although a torsional spring 144/148 is shown and described as the entry door 140 biasing mechanism of the embodiment 100, other types of door closing and locking mechanisms may be used in its stead.

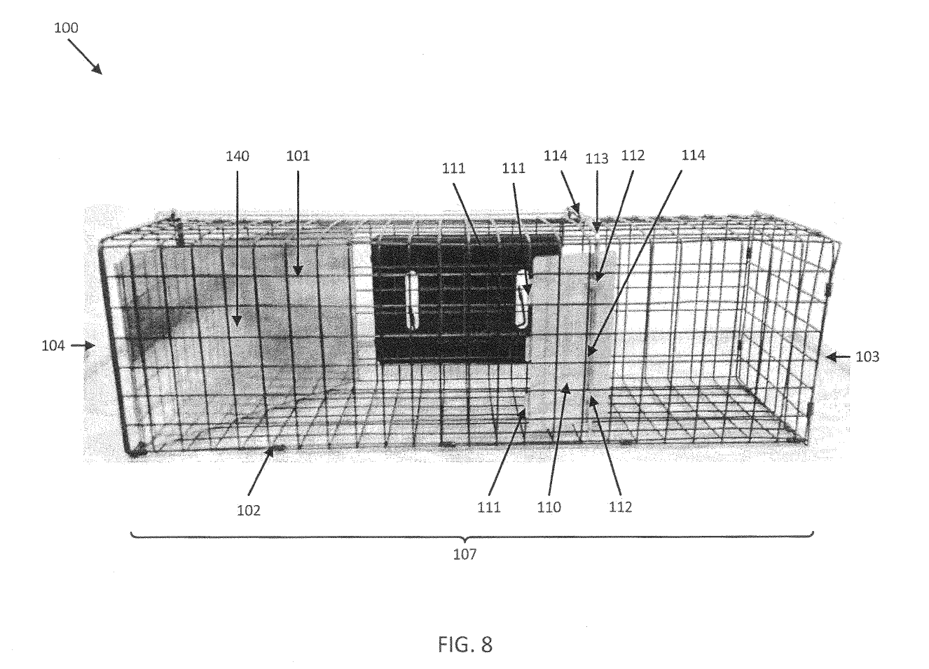

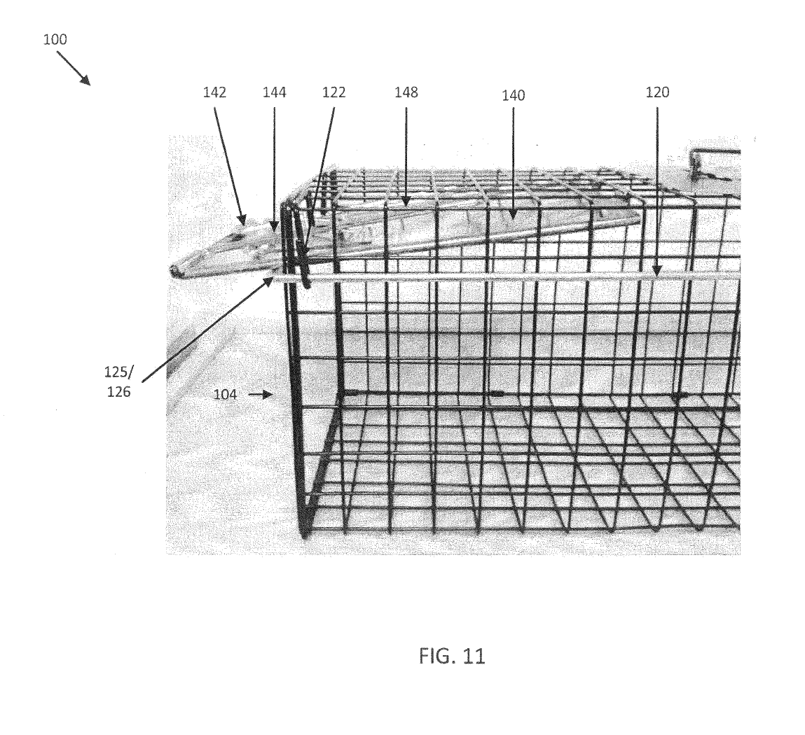

As illustrated in FIGS. 1-4 and 8-12, a trigger transfer mechanism, e.g., a transfer arm 120, is rotatably coupled to a right side 109a of enclosure 107 by fulcrum straps 121, 122, and is adapted to engage animal sensor 117 with sleeve member 124 and entry door 140 with catch 126. In some embodiments, sleeve member 124 may be implemented as a metal, plastic, or ceramic cylinder that is press-fit, welded, and/or otherwise adhered to an end of transfer arm 120. In other embodiments, sleeve member 124 may be formed from transfer arm 120 through, for example, drilling an end of transfer arm 120. Transfer arm 120 includes a moveable, e.g., rotating shaft with catch 126 disposed at a front end thereof (e.g., after bend 125) that is biased into engagement with, for example, a side and/or bottom surface of entry door 140 when the door is disposed in the open position, as illustrated in FIG. 14. In some embodiments, spring 148 is adapted to bias entry door 140, and thereby catch 126, downward so that, through action of at least bend 125 and fulcrum strap 122, transfer arm 120 experiences a counter-clockwise torque (e.g., as viewed from a front of trap 100), which is transferred to sleeve member 124 through action of at least bend 123 and fulcrum strap 121. The transferred counter-clockwise torque generates a binding and/or friction force between sleeve member 124 and tip 116 of trip release 114 (e.g., received by circular orifice 127 of sleeve member 124, which is adapted to receive the shape and a length of tip 116 of trip release 114) that is sufficient to counteract non-animal mechanical forces acting on animal sensor 117, such as gravity, wind, and other environmental forces, for example.

In one or more of the embodiments illustrated in the figures, in the open position of the entry door 140, catch 126 extends slightly outside entry opening 104 and engages the bottom surface of entry door 140 to prevent its closing. When animal sensor 117 disengages from sleeve member 124, transfer arm 120 rotates and catch 126 rotates out of engagement with entry door 140, allowing the door to close rapidly in response to the urging of spring 148.

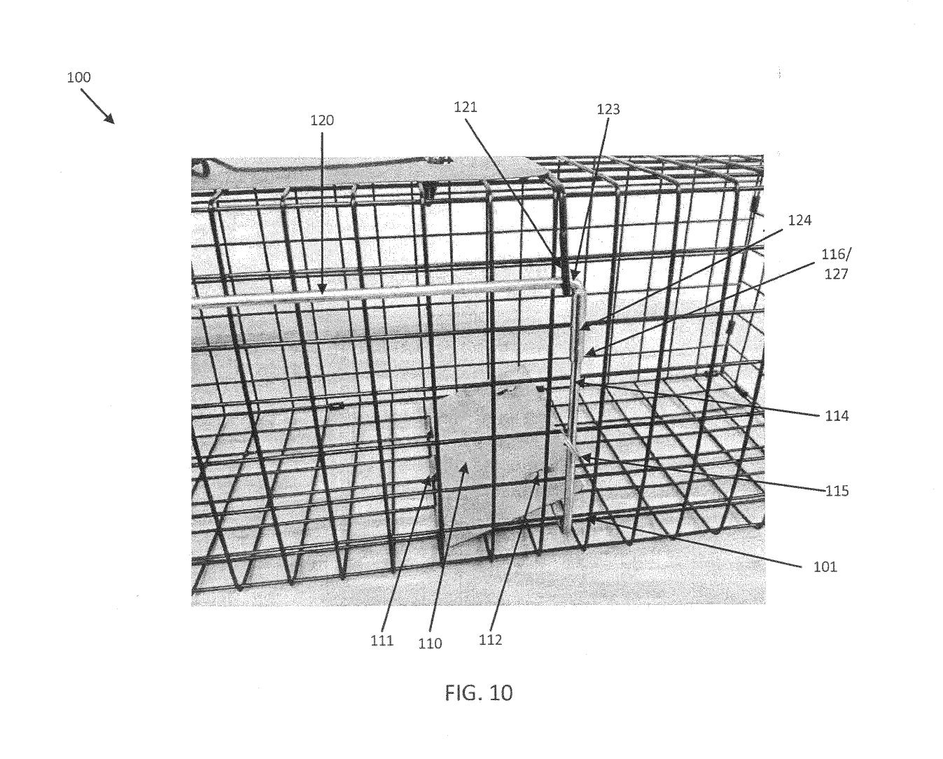

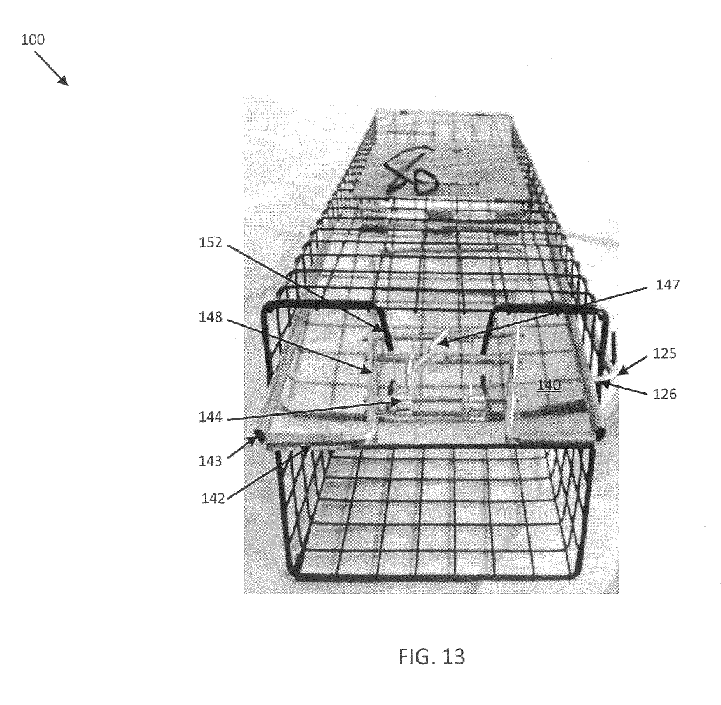

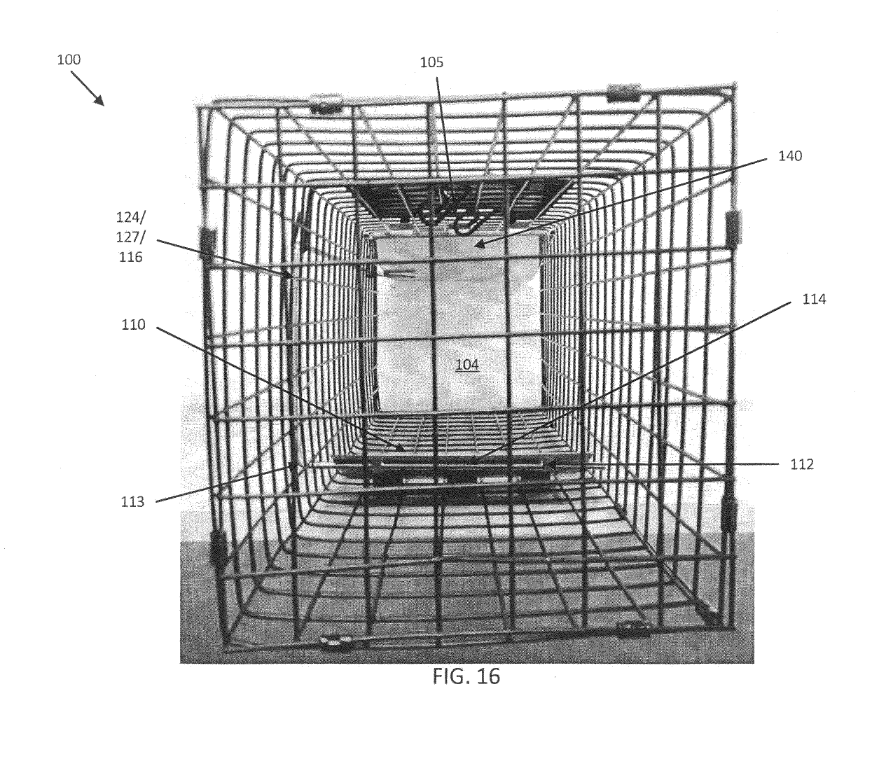

To “set,” or “arm,” entry door 140 of the trap 100, upper arm 151 of spring 148 is pressed rearwardly to unlock the door, as described above, and the door is then raised toward its open or “set” position, illustrated in FIGS. 9 and 11-16. As the door approaches catch 126, sleeve member 124 is rotated counter-clockwise, which causes catch 126 to rotate to the disengaged position relative to entry door 140. When entry door 140 is then further raised above the level of the catch, sleeve member 124 may be rotated clockwise to a vertical/down position, which allows catch 126 to rotate to the door-engaging position (e.g., see FIG. 9). Next, trip release 114 may be raised vertically, as allowed by retainer 115, to engage tip 116 and sleeve member orifice 127, as shown in FIG. 10. As noted above, once engaged, trip release 114 and sleeve member 124 may fixed relative to each other by a friction force generated by a torque applied by spring 148 through transfer arm 120. Trap 100 is then set to trap any animal that enters into the trap and presses against trip pad 110 of animal sensor 117 located toward the rear end of enclosure 107, as described above. As those of skill in the art will appreciate, other mechanisms by which transfer arm 120 engages entry door 140 and releases it in favor of the biasing spring 148 can be implemented, and accordingly, the particular trip mechanism described and illustrated herein should be understood as being only exemplary thereof, and not in any limiting sense.

For example, as shown in FIGS. 10 and 14-16, trip pad 110 may be implemented with sleeve hinge 111 coupling trip pad 110 to floor 108a of enclosure 107, which is situated closer to entry opening 104 than sleeve hinge 112 coupling trip pad 110 to trip release 114 for actuation of trip release 114 (e.g., through action of bend 113 in trip release 114). In other embodiments, trip pad 110 may be disposed on one of side walls 109a, 109b and/or top wall 108b, for example, to reduce a risk of vegetation poking through wire walls 101 of floor 108a and preventing trip pad 110 from rotating down against floor 108a and triggering trip release 114, as described above. It is understood that one or more of the sleeve hinges described herein, including sleeve hinges 111, 112, may be formed from an associated component (e.g., trip pad 110), such as through a molding, press arid/or bend process, for example, thereby eliminating cost and complexity by not requiring additional materials and/or components, particularly where the hinges are engaged with an already existing portion of enclosure 107, such as the wires forming wire walls 101. However, in other embodiments, one or more sleeve hinges may be implemented with additional materials, components, bearings, coatings, inserts, and other hinge components, for example.

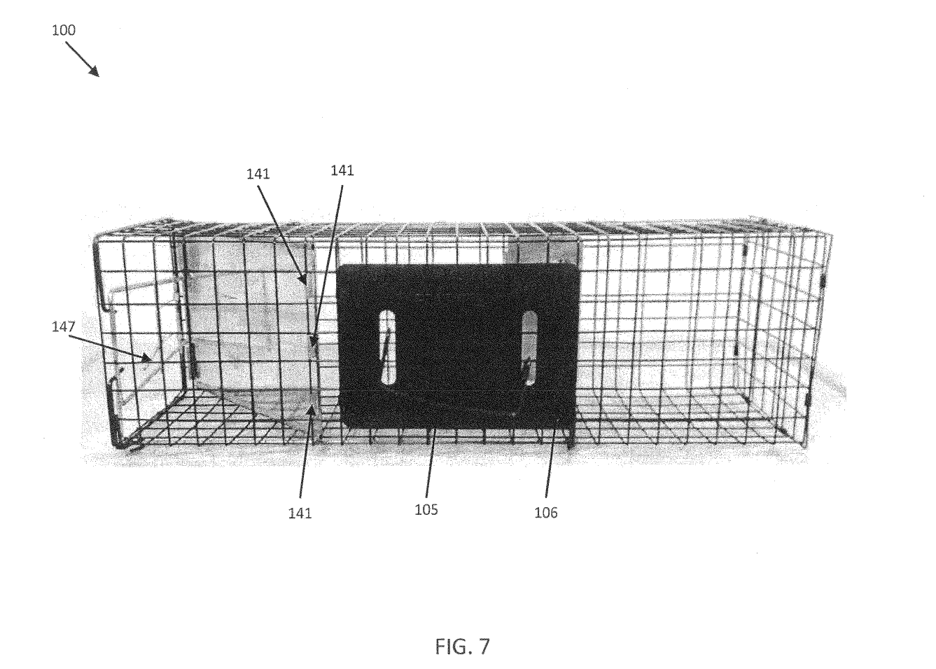

As illustrated in, e.g., FIGS. 1 and 7, enclosure 107 may further include a handle 105 and a handle guard 106 adapted to protect a user's hand from bites or scrapes when transporting a trapped animal. In some embodiments, handle 105 may be a simple, coated wire handle to reduce overall cost. In other embodiments, trap 100 may include a planar, generally rectangular exit door (e.g., in place of rear wall 103) that is slidably disposed between the end of enclosure 107 and a plurality of right-angled flanges located at one or more rear edges of enclosure 107, and that is movable up and down between an “exit closed” position, in which the exit door blocks an exit opening at the rear end of the enclosure 107, and an “exit open” position, which renders the exit opening of the enclosure wide open, to permit an animal contained in the trap to be easily released therefrom, for example, into a holding pen, a cage, or a loading chute. The exit door may include a plurality of openings (e.g., similar to the openings between wires of wire walls 101) to provide trap ventilation, and a gripping flange disposed at an upper end thereof to enable the door to be easily and safely gripped with the fingers for raising and lowering of the exit door. In related embodiments, trap 100 may further comprise a latching mechanism disposed on the enclosure 107 and adapted to latch an exit door in a closed position to prevent the escape of an animal from the trap.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure, For example, the above embodiments have described a transfer arm with a specific orientation and number of bends, catches, and/or sleeve members. However, transfer arms with other orientations, shapes, bends, and number and/or types of catches and/or sleeve members are also suitable to achieve advantages of the present invention. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A humane animal trap, comprising:
an elongated enclosure having an entry opening at a front end thereof;
an entry door disposed within the entry opening and pivotable about an upper edge thereof between an entry closed position blocking the entry opening and an entry open position disposed above and spaced apart from a floor of the enclosure;
a spring biasing the entry door toward the closed position;
a transfer arm disposed along a side of the enclosure, the transfer arm having a catch that is biased into engagement with a bottom surface of the entry door when the entry door is disposed in the entry open position and a trip release is engaged with the transfer arm, and being operable to rotate the catch from the bottom surface of the entry door in response to disengagement of the trip release; and
an animal sensor disposed in the enclosure, the animal sensor comprising a trip pad in the interior of the enclosure and coupled to the trip release, the animal sensor operable to disengage the trip release from the transfer arm when an animal enters the trap.

2. The trap of claim I, wherein the transfer arm comprises a sleeve member adapted to engage the trip release and hold the animal sensor in a set position through friction.

3. The trap of claim 2, wherein the sleeve member comprises a circular orifice adapted to receive a tip of the trip release.

4. The trap of claim 2, wherein the sleeve member is press-fit onto an end of the transfer arm.

5. The trap of claim 1, wherein the animal sensor comprises a trip pad sleeve hinged to a floor of the enclosure and to the trip release, and wherein the trip pad is adapted to trigger the trip release when an animal presses down on the trip pad.

6. The trap of claim 1, wherein the transfer arm comprises first and second bends, and wherein the transfer arm is rotatably coupled to the side of the enclosure by first and second fulcrum straps situated between the first and second bends.

7. The trap of claim 1, wherein the enclosure comprises one or more wire mesh sheets.

8. The trap of claim 1, wherein:
the enclosure comprises a first wire mesh sheet coupled to a second wire mesh sheet;
the first wire mesh sheet is formed into a top wall, floor, and two side walls of the enclosure using three bends and one or more joiners coupling two ends of the first wire mesh sheet; and
the second wire mesh sheet forms an end wall of the enclosure.

9. The trap of claim 1, wherein the spring comprises a U-shaped torsion spring, a pair of lower arms sleeve hinged to a lower edge of the entry door, and an upper arm in sliding engagement with a top wall of the enclosure, and being arranged to bias the entry door toward and lock it in the closed position.

10. The trap of claim 9, wherein the torsion spring is coupled to a first cross-bar of the spring and comprises first legs acting on a second cross-bar of the spring and second legs acting on a top surface of the entry door, thereby actuating the spring.

11. The trap of claim 9, wherein the torsion spring is coupled to a first cross-bar of the spring and comprises first legs acting on a second cross-bar of the spring and second legs acting on a top surface of the entry door, thereby actuating the spring.

12. The trap of claim 9, wherein the entry door and the upper arm and lower arms of the spring are arranged so that the entry door pushes an animal substantially towards a rear wall of the trap as the entry door is closing.

13. The trap of claim 1, wherein the entry door comprises one or more reinforcement features adapted to prevent the entry door from buckling under stress from the spring.

14. The trap of claim 13, wherein at least one of the one or more reinforcement features comprises a sleeve hinge.

15. The trap of claim 1, wherein the trap comprises one or more sleeve hinges formed from one or more associated components of the trap.

16. A humane animal trap, comprising:
an elongated enclosure having front and rear ends, a floor, upstanding and generally parallel sidewalls, a top wall, at least one handle and handle guard, and an entry opening located at the front end thereof;
an entry door disposed within the entry opening of the enclosure and moveable between an entry open position and an entry closed position blocking the entry opening;
a spring biasing the entry door toward the closed position;
a transfer arm disposed along a side of the enclosure, the transfer arm having a catch that is biased into engagement with a bottom surface of the entry door when the entry door is disposed in the entry open position and a trip release is engaged with the transfer arm, and being operable to rotate the catch from the bottom surface of the entry door in response to disengagement of the trip release; and
a sensor disposed in a rear end portion of the enclosure, the sensor comprising a trip pad extending across the interior of the floor of the enclosure and coupled to the trip release, the sensor operable to disengage the trip release from the transfer arm when an animal enters the rear end portion of the enclosure.

17. The trap of claim 16, wherein the transfer arm comprises a sleeve member adapted to engage the trip release and hold the sensor in a set position through friction generated, at least in part, by the spring.

18. The trap of claim 16, wherein the transfer arm comprises first and second bends, and wherein the transfer arm is rotatably coupled to the side of the enclosure by first and second fulcrum straps situated between the first and second bends.

19. The trap of claim 16, wherein the housing comprises a wire mesh.

20. The trap of claim 16, wherein the floor, sidewalls, top wall, and entry opening of the enclosure are formed by a single sheet of wire mesh.
